(19) United States
(12) Patent Application Publication
(10) Pub. No.: US 2008/0231137 A1
(43) Pub. Date: Sep. 25, 2008

(54) Armature, dynamo-electric machine and winding method

(75) Inventors: Kazushi Sugishima, Hamamatsu-city (JP); Toshihiro Tanino, Hamamatsu-city (JP)

Correspondence Address: POSZ LAW GROUP, PLC, 12040 SOUTH LAKES DRIVE, SUITE 101, RESTON, VA, 20191, US

(73) Assignee: ASMO CO., LTD., Kosai-city (JP)

(21) Appl. No.: 12/073,066

(22) Filed: Feb. 29, 2008

(30) Foreign Application Priority Data
Mar. 22, 2007 (JP) 2007-74615

(51) Int. Cl. H02K 13/04; H02K 15/09; H02K 3/487

(52) U.S. Cl. 310/197; 310/234; 310/89; 29/597; 242/433

(57) ABSTRACT

A coil of a winding is wound around teeth of an armature core for a predetermined number of times in a motor. A start lead of the winding connects between the coil and a corresponding start segment among a plurality of segments of a commutator. A finish lead of the winding connects between the coil and a corresponding finish segment among the plurality of segments. The finish segment is located adjacent to a diametrically opposed one of the plurality of segments, which is circumferentially displaced by about 180 degrees from the start segment and is thereby diametrically opposed to the start segment.

### CROSS REFERENCE TO RELATED APPLICATION

This application is based on and incorporates herein by reference Japanese Patent Application No. 2007-74615 filed on Mar. 22, 2007.

### BACKGROUND OF THE INVENTION

1. Field of the Invention

The present invention relates to an armature, a dynamo-electric machine having the same and a winding method of windings of the armature.

2. Description of Related Art

For example, Japanese Unexamined Patent Publication No. 2005-341654 discloses windings of an armature of a direct current brush motor (dynamo-electric machine). The windings are wound by a long alpha-type connecting method, which forms alpha-type loop connections. FIGS. 11A to 12B show an armature core 10 of a prior art armature, which includes windings (only one is shown in FIGS. 11A and 11B) that are wound to have the alpha-type loop connections. FIG. 12A is a development view of the armature of FIG. 11A, and FIG. 12B is a development view of the armature of FIG. 11B. The armature further includes a commutator 12, which includes sixteen segments 16. The armature core 10 includes sixteen core teeth 13, which define sixteen slots 14. The sixteen slots 14 are sequentially numbered as first to sixteenth slots 14 starting from a predetermined position (a bottom left side slot 14) in FIGS. 11A and 11B, and the sixteen segments 16 are similarly sequentially numbered as first to sixteenth segments 16 starting from a predetermined position (a bottom left side segment 16) in FIGS. 11A and 11B. As shown in FIG. 11A, a winding is first connected to the first segment 16 (specifically, a riser or connecting claw 17 of the segment 16) and is then wound around three (hereinafter, referred to as teeth 13a) of the teeth 13 between the eighth slot 14 and the eleventh slot 14, which are located opposite from the first segment 16 with respect to a rotatable shaft 9, so that a coil 121 is formed. Then, the winding is connected to the second segment 16, which is adjacent to the first segment 16. As described above, the ends of the coil 121 are connected to the first and second segments 16, respectively, which are located outside of the angular range of the coil 121. The section of the winding, which connects between the coil 121 and the first segment 16, is called as a start lead 150a, and the other section of the winding, which connects between the coil 121 and the second segment 16 is called as a finish lead 150b.

FIG. 11B shows the armature, in which a short-circuit line 122 is formed to connect between the first segment 16 and the ninth segment 16 that are diametrically opposed to each other about a rotational axis of the rotatable shaft 9. In FIG. 11B, unlike FIG. 11A, the winding having the start lead 150a and the finish lead 150b is connected between the ninth segment 16 and the tenth segment 16. The short-circuit line 122 is provided as an equalizing line or a distribution line. The equalizing line short circuits between the corresponding segments, which should have the same electric potential, to cancel a deviation in commutation timing between power supply brushes. In this way, it is possible to reduce a magnetic field unbalance (noise, vibration) caused by an induced voltage distortion and also to reduce generation of a spark caused by a difference in the electric potential. The distribution line short circuits between the corresponding segments, which should have the same electric potential, to reduce the number of the power supply brushes.

However, in the previously proposed winding method of the windings, the start lead and the finish lead of each winding are placed generally all around the rotatable shaft 9. Thus, the windings are generally overcrowded to hinder placement of the coils 121 of the windings. Furthermore, a space factor is reduced, and coil ends are lengthened. Thus, when the space factor is reduced or limit, the size of the motor needs to be disadvantageously increased. Also, in the case of providing the short-circuit lines 122, the number of windings or wires between the armature core (rotor core) and the commutator having the segments is disadvantageously increased to cause the increased overcrowding of the windings. Thus, the armature core and the commutator cannot be placed close to each other, so that the axial length of the motor is disadvantageously increased.

### SUMMARY OF THE INVENTION

The present invention addresses at least one of the above disadvantages. According to one aspect of the present invention, there is provided an armature for a dynamo-electric machine. The armature includes a rotatable shaft, an armature core, a commutator and at least one winding. The armature core is installed to the rotatable shaft to rotate therewith and includes a plurality of teeth. The commutator is installed to the rotatable shaft to rotate therewith and includes a plurality of segments, which are slidably engageable with a plurality of power supply brushes of the dynamo-electric machine that includes two diametrically opposed power supply brushes. The two diametrically opposed power supply brushes are circumferentially displaced from each other by about 180 degrees about a rotational axis of the rotatable shaft and provide generally the same electric potential to corresponding two, respectively, of the plurality of segments, which are engaged with the two diametrically opposed power supply brushes. Each winding includes a coil, a start lead and a finish lead. The coil is wound around at least one of the plurality of teeth for a predetermined number of times. The start lead connects between the coil and a corresponding start segment among the plurality of segments. The finish lead connects between the coil and a corresponding finish segment among the plurality of segments. The finish segment is located adjacent to a diametrically opposed one of the plurality of segments, which is circumferentially displaced by about 180 degrees from the start segment and is thereby diametrically opposed to the start segment.

According to another aspect of the present invention, there is provided a dynamo-electric machine, which includes the above armature, a motor housing, a plurality of magnets, at least one cathode power supply brush and at least one anode power supply brush. The motor housing receives the armature. The magnets are fixed to an inner peripheral surface of the motor housing and are circumferentially arranged one after another at generally equal angular intervals. The at least one cathode power supply brush and the at least one anode power supply brush are slidably engageable with the plurality of segments of the commutator.

According to another aspect of the present invention, there is also provided a winding method. According to this method, a wire is connected to a corresponding start segment among a plurality of segments of a commutator to form a start lead of a winding. Then, the wire is wound around at least one of a plurality of teeth of an armature core to form a coil of the winding after the start lead. Next, the wire is connected to a corresponding finish segment among the plurality of segments to form a finish lead of the winding after the coil. The finish segment is located adjacent to a diametrically opposed one of the plurality of segments, which is circumferentially displaced by about 180 degrees from the start segment and is thereby diametrically opposed to the start segment.

### BRIEF DESCRIPTION OF THE DRAWINGS

The invention, together with additional objectives, features and advantages thereof, will be best understood from the following description, the appended claims and the accompanying drawings in which:

FIG. 1 is a partially fractured schematic view of a dynamo-electric machine according to a first embodiment of the present invention;

FIG. 2 is a partial plan view of the dynamo-electric machine of the first embodiment;

FIG. 3 is a schematic diagram showing a winding pattern of windings in an armature according to the first embodiment;

FIG. 4 is a partial development view of the armature according to the first embodiment;

FIG. 5 is a schematic diagram showing a winding pattern of windings in an armature according to a second embodiment of the present invention;

FIG. 6 is a partial development view of the armature according to the second embodiment;

FIG. 7 is a schematic diagram showing a winding pattern of windings in an armature of a modification of the second embodiment;

FIG. 8 is a partial development view of the armature shown in FIG. 7;

FIGS. 9A and 9B are schematic diagrams showing different winding patterns of windings in an armature of another modification of the second embodiment;

FIGS. 10A and 10B are partial development views showing the windings of FIGS. 9A and 9B, respectively;

FIGS. 11A and 11B are schematic diagrams showing different winding patterns of windings in an armature of a prior art; and

FIGS. 12A and 12B are partial development views showing the windings of FIGS. 11A and 11B, respectively.

### DETAILED DESCRIPTION OF THE INVENTION

### First Embodiment

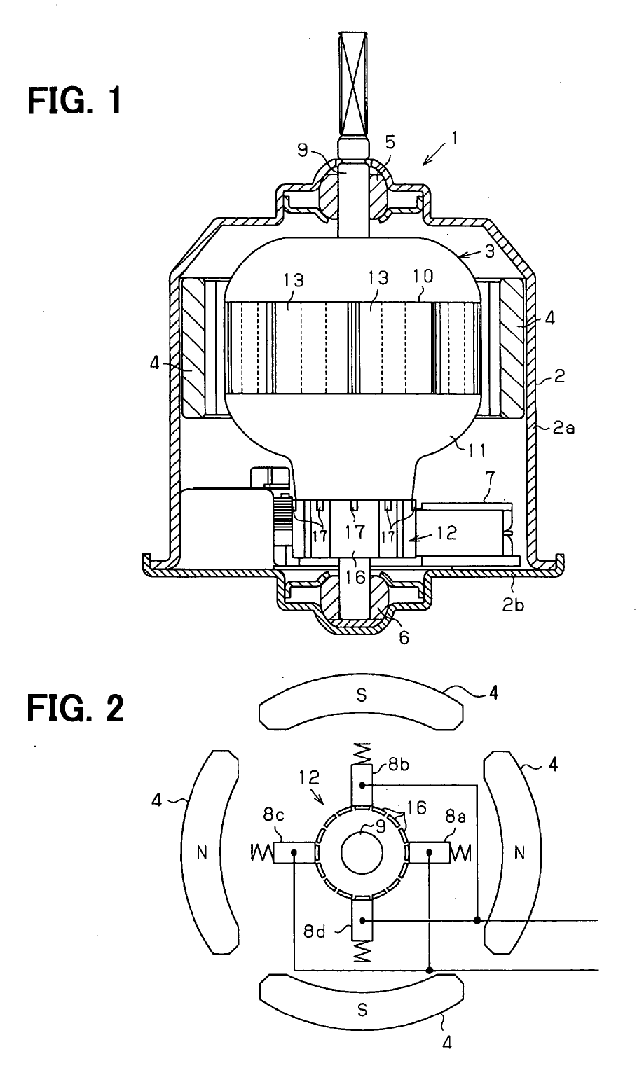

A first embodiment of the present invention will be described with reference to FIGS. 1 to 4.

As shown in FIG. 1, a motor 1 includes a motor housing 2 and an armature 3. The armature 3 is received in the motor housing 2. A yoke housing 2a of the motor housing 2 is formed into a cup-shaped body. A plurality (four in this instance) of permanent magnets 4 is fixed to an inner peripheral surface of the yoke housing 2a such that the magnets 4 are arranged one after another at generally equal angular intervals in a circumferential direction. Specifically, as shown in FIG. 2, the motor 1 of the present embodiment includes four magnets 4, each of which has an arcuate cross section, and these magnets 4 are arranged at generally equal intervals in the circumferential direction of the motor housing 2 to provide alternating polarities in the circumferential direction. That is, the number of polarities of the magnets 4 is four.

Furthermore, a bearing 5 is provided in a bottom center (a top center in FIG. 1) of the yoke housing 2a, and an opening of the yoke housing 2a is closed with an end frame (end cover) 2b that is formed as a generally circular plate. A bearing 6, which is paired with the bearing 5, is provided in the center of the end frame 2b. Furthermore, four brush holders 7 are provided in an inner surface (yoke housing 2a side surface) of the end frame 2b. FIG. 1 shows only one of the brush holders 7. Each brush holder 7 is configured into a quadrangular tubular body. The brush holders 7 are arranged generally at 90 degree intervals in the circumferential direction. As shown in FIG. 2, a power supply brush 8a-8d, which is configured into a quadrangular prism body, is slidably received in each brush holder 7.

A rotatable shaft 9 of the armature 3 is rotatably supported by the bearings 5, 6, and a distal end portion of the rotatable shaft 9 projects outward from the yoke housing 2a. An armature core 10 is fixed to an axial center part of the rotatable shaft 9 and includes a winding arrangement 11, which includes a plurality of windings 15 that are wound around the armature core 10. A commutator 12 is fixed to a based end side of the rotatable shaft 9.

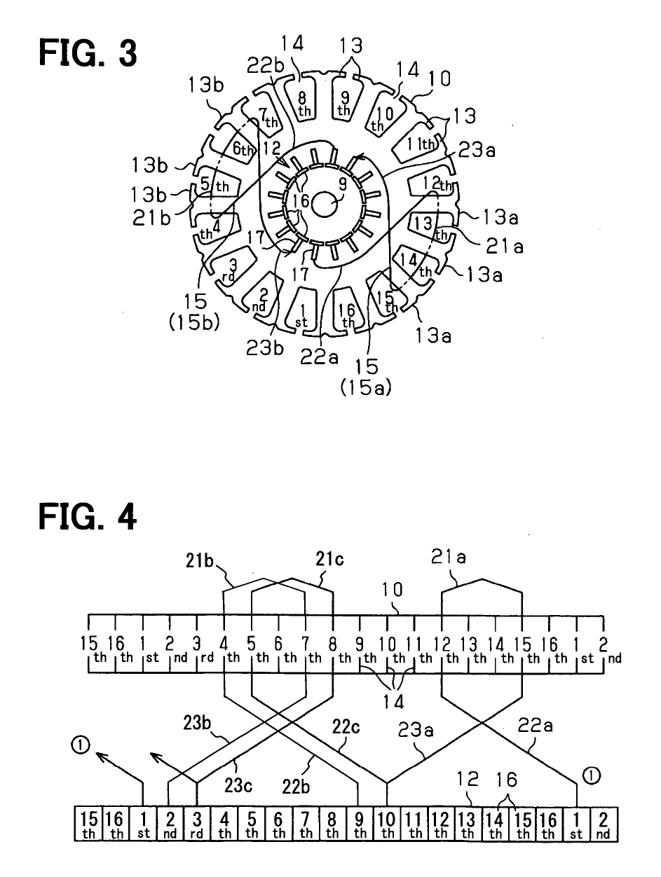

As shown in FIG. 3, the armature core 10 includes a plurality (sixteen in the present embodiment) of teeth 13. The teeth 13 are arranged around the rotatable shaft 9 at generally equal angular intervals and extend radially outward. Furthermore, radially inner ends of the teeth 13 are interconnected in the circumferential direction, so that the armature core 10 is configured into a generally annular form. Furthermore, a dielectric insulator (not shown) is installed to the armature core 10 to covers the armature core 10 from both axial sides except an inner peripheral surface and an outer peripheral surface (i.e., radially outer end surfaces of the teeth 13) of the armature core 10. A slot 14 is circumferentially defined between each adjacent two of the teeth 13 to receive the corresponding winding 15.

Windings 15, which constitute the winding arrangement 11, are wound around the teeth 13 of the armature core 10 such that each winding 15 is wound over at least one of the teeth 13. In the present embodiment, each winding 15 is wound over a plurality (three in FIG. 3) of the teeth 13 (slots 14). That is, the windings 15 are wound in a distributed winding pattern.

The commutator 12 is formed into a cylindrical body. A plurality (sixteen in the present embodiment as shown in FIG. 2) of commutator segments 16 is provided in an outer peripheral surface of the commutator 12 to extend in the axial direction of the rotatable shaft 9. As shown in FIG. 2, the segments 16 are arranged one after another at generally equal angular intervals in the circumferential direction of the commutator 12. As shown in FIG. 1, each segment 16 includes a riser (connecting claw) 17, which is connected with a start end or a finish end of the corresponding winding 15. Thus, each winding 15 includes a coil and two connections. The coil is wound around the corresponding teeth 13 of the armature core 10. The connections connect the coil to the corresponding segments 16, respectively. The connections are referred as leads.

As shown in FIG. 2, the multiple (four in this embodiment) power supply brushes 8a-8d, which are arranged generally at predetermined angular intervals, are slidably engaged with the commutator 12. Among the four power supply brushes 8a-8d, a first power supply brush 8a and a third power supply brush 8c are diametrically opposed to each other (i.e., circumferentially displaced from each other by about 180 degrees) and are electrically connected with each other. Similarly, a second power supply brush 8b and a fourth power supply brush 8d are diametrically opposed to each other and are electrically connected with each other. The first power supply brush 8a and the third power supply brush 8c are connected to a cathode terminal of an electric power source (not shown) and thereby serve as cathode power supply brushes. The second power supply brush 8b and the fourth power supply brush 8d are connected to an anode terminal of the electric power source and thereby serve as anode power supply brushes. Thus, the power supply brushes 8a, 8c (or 8b, 8d) of each brush pair are simultaneously engaged with the two diametrically opposed segments 16 of the commutator 12, which are diametrically opposed to each other about the rotatable shaft 9, to provide the same electric voltage to the segments 16. When the electric power is supplied to the winding arrangement 11 from the power supply brushes 8a-8d through the commutator 12, the electric current flows through the windings 15 of the winding arrangement 11 to form the magnetic poles. The attractive and repulsive forces between the thus generated magnetic poles and the magnets 4 cause rotation of the armature 3. Upon rotation of the armature 3, the contact points of the power supply brushes 8a-8d relative to the commutator 12 are sequentially displaced, so that the magnetic poles of the winding arrangement 11 (windings 15) occur at generally the same positions relative to the magnets 4, and thereby the rotation of the motor 1 is maintained.

Next, the windings 15 of the armature core 10 will be described with reference to FIGS. 3 and 4.

FIG. 3 shows two of the windings 15. FIG. 4 is a partial development view of the armature. In the armature core 10 shown in FIGS. 3 and 4, the total number of the segments 16 is sixteen, and the total number of the teeth 13 is sixteen. Accordingly, the total number of slots 14, which are defined by the teeth 13, is also sixteen. The sixteen slots 14 are sequentially numbered as first to sixteenth slots 14 starting from a predetermined position (a bottom left side slot 14) in FIG. 3, and the sixteen segments 16 are similarly sequentially numbered as first to sixteenth segments 16 starting from a predetermined position (a bottom left side segment 16) in FIG. 3.

As shown in FIG. 3, one of the windings 15 (hereinafter, referred to as a first winding 15a for the descriptive purpose) is connected between the first segment 16 and the tenth segment 16, and another one of the windings 15 (hereinafter, referred to as a second winding 15b for the descriptive purpose) is connected between the ninth segment 16 and the second segment 16. An arrowhead of each winding 15a, 15b in FIG. 3 indicates a winding direction of the winding 15a, 15b. Specifically, the first winding 15a is formed as follows. That is, a start end portion of the first winding (wire) 15a is first securely engaged with the first segment 16 (specifically, the riser 17 of the first segment 16). Then, the same winding 15a is wound around corresponding three (hereinafter, referred to as teeth 13a) of the teeth 13. Thereafter, a finish end portion of the same winding 15a is securely engaged with the tenth segment 16. With respect to the first winding 15a, the first segment 16, to which the start end portion of the winding 15a is securely engaged, will be referred to as a start segment 16, and the tenth segment 16, to which the finish end portion of the winding 15a is securely engaged, will be referred to as a finish segment 16. The first winding 15a includes a coil 21a, a start lead 22a and a finish lead 23a. The coil 21a is formed by winding the first winding 15a around the three teeth 13a a predetermined number of times. The start lead 22a connects between the coil 21a and the start segment 16, and the finish lead 23a connects between the coil 21a and the finish segment 16. In FIG. 3, the coil 21a is indicated as a line that extends over the three teeth 13a for the sake of simplicity. However, in reality, the coil 21a is formed by winding the winding 15a around the teeth 13a the predetermined number of times (e.g., ten times)

The coil 21a is formed by this section of the winding 15a, which is wound around the three teeth 13a. A middle one of the three teeth 13a, which is placed in the center of the three teeth 13a in the circumferential direction, is circumferentially spaced about 90 degrees from the start segment 16, to which the start end portion of the winding 15a is connected, around the rotational axis of the rotatable shaft 9. More specifically, the coil 21a is formed by winding the winding 15a around the center tooth 13a, which is centered in the angular range about the rotatable shaft 9 between the start segment 16 and the finish segment 16, and the other two circumferentially adjacent teeth 13a. Thus, a length of the start lead 22a, which connects between the coil 21 and the start segment 16, is generally the same as a length of the finish lead 23a, which connects between the coil 21a and the finish segment 16.

Furthermore, in FIG. 3, the coil 21a is received in the twelfth slot 14 and the fifteenth slot 14 and is wound around the three teeth 13a located between the twelfth slot 14 and the fifteenth slot 14. Thus, the start lead 22a extends between the first segment 16 and the twelfth slot 14, and the finish lead 23a extends between the fifteenth slot 14 and the tenth segment 16. The first segment 16 and the twelfth slot 14 are circumferentially spaced from each other by the angle of about 90 degrees or more around the rotatable shaft 9, and the fifteenth slot 14 and the tenth segment 16 are circumferentially spaced from each other by the angle of about 90 degrees or more around the rotatable shaft 9. Thus, when the winding arrangement 11 of the above type is applied to a generally flat type direct current electric motor, each of the start lead 22a and the finish lead 23a of the winding 15a is pulled at the angle of about 90 degrees or more relative to a projecting direction of the riser 17 of the corresponding segment 16, to which the lead 22a, 23a is connected. Therefore, it is possible to limit unintentional removal of the lead 22a, 23a from the riser 17 of the corresponding segment 16.

Similar to the first winding 15a, the second winding 15b is formed as follows. That is, a start end portion of the second winding (wire) 15b is first securely engaged with the ninth segment 16 (specifically, the riser 17 of the ninth segment 16). Then, the same winding 15b is wound around corresponding three (hereinafter, referred to as teeth 13b) of the teeth 13. Thereafter, a terminal end portion of the same winding 15b is securely engaged with the second segment 16. With respect to the second winding 15b, the ninth segment 16, to which the start end portion of the winding 15b is securely engaged, will be referred to as the start segment 16, and the second segment 16, to which the terminal end portion of the winding 15b is securely engaged, will be referred to as the finish segment 16. The second winding 15b includes a coil 21b, a start lead 22b and a finish lead 23b. The coil 21b is formed by winding the second winding 15b around the three teeth 13b a predetermined number of times. The start lead 22b connects between the coil 21b and the start segment 16, and the finish lead 23b connects between the coil 21b and the finish segment 16.

The second winding 15b has the structure and connections, which are similar to those of the first winding 15a. Thus, the start lead 22b and the finish lead 23b, which are connected to the ends, respectively, of the coil 21b, have generally the same length. Furthermore, each of the start lead 22b and the finish lead 23b of the winding 15b is pulled at the angle of about 90 degrees or more relative to the projecting direction of the riser 17 of the corresponding segment 16, to which the lead 22b, 23b is connected. Therefore, it is possible to limit unintentional removal of the lead 22b, 23b from the riser 17 of the corresponding segment 16.

The start segment 16, to which the first winding 15a is connected, is the first segment 16, and the start segment 16, to which the second winding 15b is connected, is the ninth segment 16. Since the commutator 12 includes the sixteen segments 16, the first segment 16 and the ninth segment 16 are symmetrically positioned about the rotational axis of the rotatable shaft 9, i.e., are circumferentially displaced from each other by about 180 degrees about the rotational axis of the rotatable shaft 9. The first winding 15a is formed between the first segment 16 and the tenth segment 16, which is adjacent to the ninth segment 16. Furthermore, the second winding 15b is formed between the ninth segment 16 and the second segment 16, which is adjacent to the first segment 16. Therefore, the first winding 15a and the second winding 15b are symmetrically positioned about the rotational axis of the rotatable shaft 9, i.e., are circumferentially displaced from each other by about 180 degrees around the rotational axis of the rotatable shaft 9. Furthermore, two of the brushes 8a-8d, which apply the same voltage, simultaneously contact the first segment 16 and the ninth segment 16, respectively. Therefore, the first winding 15a and the second winding 15b are simultaneously energized. Specifically, the magnetic poles of the same polarity are provided to the two diametrically opposed locations, respectively, which are circumferentially displaced from each other by about 180 degrees.

The windings 15 (including the windings 15a, 15b) are formed by winding supply wires with a double flyer winding machine. In the present embodiment, the first winding 15a is wound around the corresponding three teeth 13a to form the coil 21a, and at the same time the second winding 15b is wound around the corresponding teeth 13b, the circumferentially center one of which is displaced by about 180 degrees from the circumferentially center one of the three teeth 13a, to form the corresponding coil 21b. In this way, the two diametrically opposed windings 15a, 15b, which are circumferentially displaced from each other by about 180 degrees, can be simultaneously formed.

The angles of the start lead 22a, 22b and the finish lead 23a, 23b relative to the rotatable shaft 9 have influences on the winding property of the risers 17. As shown in FIG. 1, in the case where the armature core 10 and the commutator 12 are axially spaced from each other by the relatively long distance, even when the winding 15 is wound starting from the slot 14, which is spaced from the start segment 16 only by the relatively short distance, the winding 15, which is wound to the riser 17 of the start segment 16, is not unintentionally released from the riser 17 of the start segment 16. However, in the case of the generally flat direct current electric motor, which has the relatively small axial size, the axial distance between the armature core 10 and the commutator 12 is relatively small. Therefore, when the start slot 14 or the finish slot 14 is located in the projecting direction of the riser 17, the winding 15 may be unintentionally easily released from the riser 17. In contrast, in the case of the winding 15 of the present embodiment, the start segment 16 is circumferentially spaced from the start slot 14 (i.e., the slot 14 where the start lead 22a, 22b is extended) by the angle of about 90 degrees or more, and the finish segment 16 is circumferentially spaced from the finish slot 14 (i.e., the slot 14 where the finish lead 23a, 23b is extended) by the angle of about 90 degrees or more. Thus, when the winding arrangement 11 of the present embodiment is applied to the generally planar dielectric current electric motor, each of the start lead 22a, 22b and the finish lead 23a, 23b of the winding 15a, 15b is pulled at the angle of about 90 degrees or more relative to the projecting direction of the riser 17 of the corresponding segment 16, to which the lead 22a, 22b, 23a, 23b is connected. Therefore, it is possible to limit unintentional removal of the lead 22a, 22b, 23a, 23b from the riser 17 of the corresponding segment 16.

In the present embodiment, the first winding 15a and the second winding 15b are wound around the corresponding teeth 13a, 13b such that the length of the start lead 22a, 22b is generally the same as the length of the finish lead 23a, 23b. For example, the distance between the first segment 16, which is connected to the start lead 22a, and the start slot 14 (i.e., the slot 14 where the start lead 22a is extended), is generally the same as the distance between the tenth segment 16, which is connected to the finish lead 23a, and the finish slot 14 (i.e., the slot 14 where the finish lead 23a is extended). Thus, each of the start lead 22a and the finish lead 23a is pulled at generally the same angle relative to the projecting direction of the riser 17 of the corresponding segment 16, to which the lead 22a, 23a is connected. Therefore, it is possible to limit unintentional removal of the lead 22a, 23a from the riser 17 of the corresponding segment 16.

The windings 15 of the winding arrangement 11 also include other windings 15, which are other than the first winding 15a and the second winding 15b. For example, as shown in FIG. 4, a start lead 22c of another winding 15 extends from the tenth segment 16, and this winding 15 is wound around corresponding three of the teeth 13 to form a coil 21c and is thereafter connected to the third segment 16 through a finish lead 23c.

Next, advantages of the first embodiment will be described.

(1) The diametrically opposed two of the power supply brushes (i.e., the power supply brush 8a and the power supply brush 8c or the power supply brush 8b and the power supply brush 8d) are engaged with the two diametrically opposed segments 16, respectively, which are circumferentially displaced from each other about 180 degrees about the rotational axis of the rotatable shaft 9, so that these two diametrically opposed segments 16 have the same electric potential. Each winding 15 is connected to the one of the corresponding two diametrically opposed segments 16 and is also connected to an adjacent segment 16, which is adjacent to the other one of the corresponding two diametrically opposed segments 16. Thus, each winding 15 is connected to the one of the diametrically opposed segments 16 and the segment 16 that is adjacent to the other one of the diametrically opposed segments 16, which is displaced from the one of the diametrically opposed segments 16 by about 180 degrees. In this way, the length of each of the start lead and the finish lead of the winding 15 is reduced, so that the mass of the windings between the armature core and the commutator can be reduced.

(2) Each winding 15 is wound around the corresponding teeth, which make it possible to reduce the angle between the start segment (e.g., the first segment 16) and the finish segment (e.g., the tenth segment 16) about the rotatable shaft 9. In this way, it is possible to form the windings, each of which has the relatively short start lead and the relatively short finish lead.

(3) The winding 15 is wound around the corresponding teeth 13 such that the length of the start lead 22a, 22b connected to the start segment and the length of finish lead 23a, 23b connected to the finish segment are generally the same. Thus, each of the start lead 22a, 22b and the finish lead 23a, 23b is pulled at generally the same angle relative to the corresponding one of the start segment 16 and the finish segment 16. Therefore, it is possible to limit unintentional removal of the lead 22a, 22b, 23a, 23b from the corresponding segment 16.

(4) The windings 15 are wound by the double flyer winding machine such that the diametrically opposed windings 15 are simultaneously wound around the corresponding teeth 13. A winding diagram of the winding machine can be changed only by changing an operational program of the winding machine. Furthermore, two flyers are used to simultaneously wind the two windings. Thus, the winding efficiency of the winding machine can be improved. Therefore, the work efficiency is improved to shorten the required manufacturing time, so that the manufacturing costs can be reduced.

### Second Embodiment

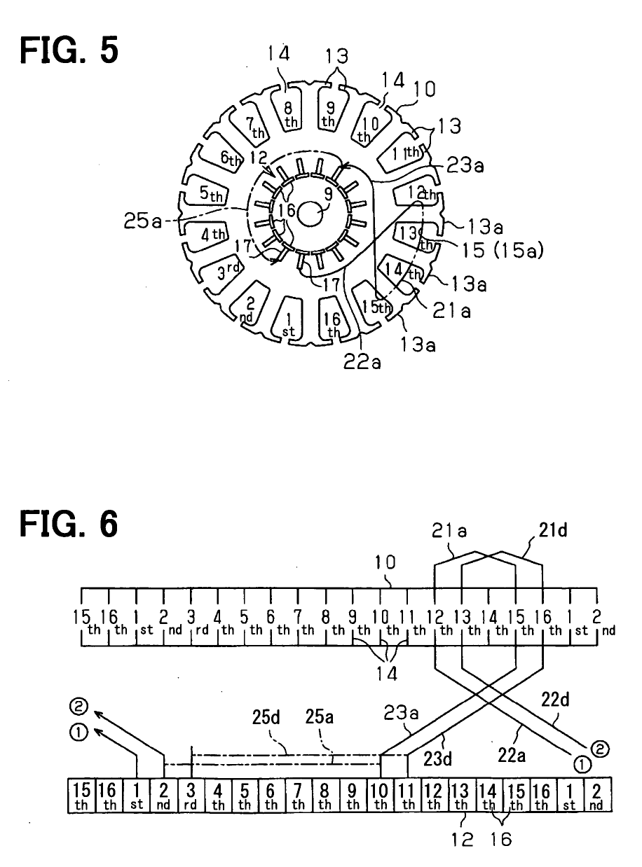

A second embodiment of the present invention will be described with reference to FIGS. 5 and 6.

The present embodiment differs from the first embodiment with respect to the windings. In the second embodiment, components similar to those of the first embodiment will be indicated by the same reference numerals and will not be described further for the sake of simplicity.

FIG. 5 is an axial view of the armature. FIG. 6 is a partial development view of the armature.

As shown in FIG. 5, the first winding 15a, which is similar to that of the first embodiment, is wound around the armature core 10. Furthermore, a short-circuit line 25a is connected between the tenth segment 16 and the second segment 16. The short-circuit line 25a is formed continuously after the first winding 15a. Thereby, the winding and the short-circuit line may be alternately formed in a continuous manner.

The two segments 16, which are interconnected by the short-circuit line 25a, are diametrically opposed to each other and are thereby displaced from each other by about 180 degrees around the rotatable shaft 9. Thus, the two diametrically opposed segments 16 contact the diametrically opposed brushes, which supply the same voltage. Specifically, the short-circuit line 25a connects between the segments 16, to which the brushes that supply the same voltage are respectively engaged. In FIG. 5, although only one short-circuit line 25a is shown, other diametrically opposed segments are also interconnected by the short-circuit lines. For example, FIG. 6 shows another winding 15, which includes a start lead 22d, a coil 21d and a finish lead 23d. Here, the start lead 22d extends from the second segment 16. The coil 21d is wound around the corresponding three teeth 13. The finish lead 23d is connected to the eleventh segment 16. With respect to this winding 15, a short-circuit line 25b circuit is provided to connect between the eleventh segment 16 and the third segment 16.

Returning to the short-circuit line 25a, circuit the short-circuit line 25a circuit connects the finish segment 16, which is connected with the finish lead 23a circuit of the first winding 15a circuit shown in FIGS. 3 and 5, and the other finish segment 16, which is connected with the finish lead 23b circuit of the second winding 15b shown in FIG. 3. Thus, even when one of the diametrically opposed power supply brushes (e.g., the second power supply brush 8b and the fourth power supply brush 8d in FIG. 2), which are engaged with the two diametrically opposed segments 16, experiences a contact malfunction with the corresponding segment 16, the drive electric current can still flow through the first winding 15a and the second winding 15b. As described above, the first winding 15a and the second winding 15b are diametrically opposed to each other and are thereby displaced from each other by about 180 degrees about the rotatable shaft 9. Thus, the electromagnetic force is simultaneously generated in both of the first winding 15a and the second winding 15b. The electromagnetic force of the first winding 15a is generally the same as the electromagnetic force of the second winding 15b in terms of its magnitude but are directed in opposite directions, respectively. Therefore, in the armature of the present embodiment, the electromagnetic forces are well balanced and will not generate any drift force, which causes a radial displacement of the armature. As a result, it is possible to limit generation of rotational vibrations or noises caused by the contact malfunction of the brushes or a deviation in the contact timing or commutation timing.

Next, additional advantages of the second embodiment, which are implemented in addition to the above-described advantages of the first embodiment, will be described.

(1) The armature of the dynamo-electric machine includes the short-circuit lines 25a, 25d and the rotatable shaft 9. Each short-circuit line 25a, 25d is placed radially outward of the start leads 22a-22d and the finish leads 23a-23d of the windings 15 and connects between the corresponding two segments 16. The armature core 10 and the commutator 12 are installed to the rotatable shaft 9. Each winding 15 is connected to the one of the two diametrically opposed segments 16 and is also connected to the adjacent segment, which is adjacent to the other one of the two diametrically opposed segments 16. The start segment (e.g., the first segment 16) and the finish segment (e.g., the tenth segment 16), which are connected with this winding 15, have the different electrode characteristics, respectively. Furthermore, this finish segment is the adjacent segment, which is adjacent to the segment that is displaced from the start segment by about 180 degrees around the rotatable shaft 9. The short-circuit line 25a, 25b is connected continuously after the winding 15. Thus, when the short-circuit lines 25a, 25d are added as the equalizing lines for improving the commutation, it is possible to achieve the reduced noise, the reduced vibration and the increased lifetime of the motor. Furthermore, when the short-circuit lines 25a, 25d are added as the distribution lines, it is possible to reduce the number of power supply brushes and the total mass of the windings. Thus, it is possible to reduce the manufacturing costs.

(2) Each short-circuit line 25a, 25d is provided continuously after the corresponding winding 15. Thus, each short-circuit line 25a, 25d is formed as the continuous line of the winding 15. When the short-circuit line 25a, 25d is added in a manner that holds the start lead 22a-22d and the finish lead 23a-23d in place, the start lead 22a-22d and the finish lead 23a-23d can be held effectively. Thereby, it is possible to make the dynamo-electric machine compact.

(3) Each winding 15 is connected to the one of the corresponding two diametrically opposed segments 16 and is also connected to the adjacent segment 16, which is adjacent to the other one of the two diametrically opposed segments 16. Furthermore, the start lead 22a and the finish lead 23a have generally the same length. Thus, the magnetic forces are simultaneously generated in the coils at the corresponding intervals. Therefore, even when unstable contact of the power supply brushes 8a-8d with the corresponding segments 16 occur, it is possible to limit occurrence of the deviation in the magnetic balance.

The above embodiments may be modified in the following manner.

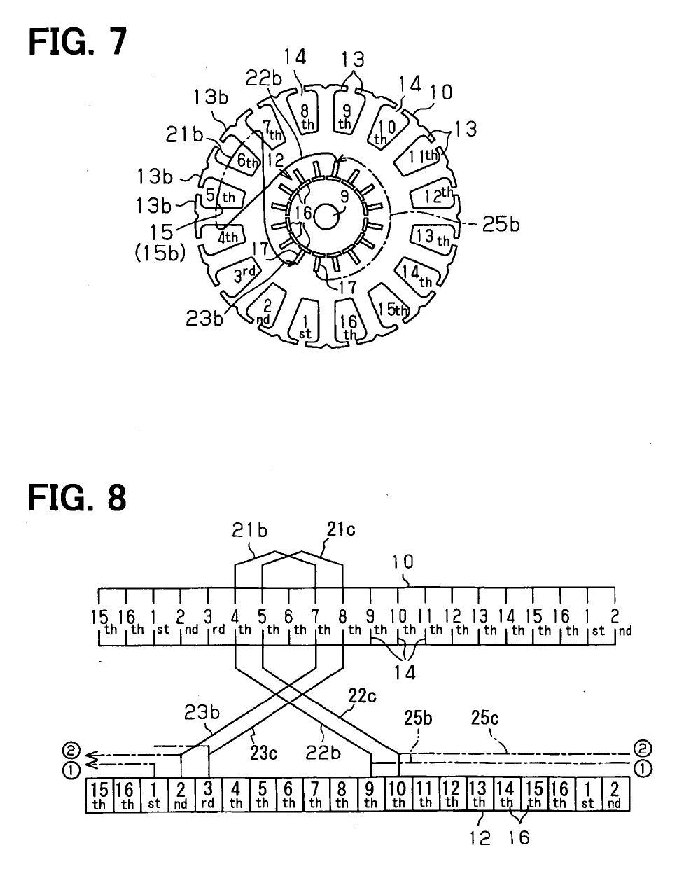

In the second embodiment, the short-circuit line 25a is formed after the finish lead 23a of the winding 15a. This may be modified in a manner shown in FIGS. 7 and 8. Specifically, as shown in FIGS. 7 and 8, the start lead 22b of winding 15b may be formed continuously after a short-circuit line 25b. Similarly, as shown in FIG. 8, a short-circuit line 25c, which connects between the second segment 16 and the tenth segment 16, may be formed first, and then the start lead 22c of the winding 15 shown in FIG. 4 may be formed thereafter.

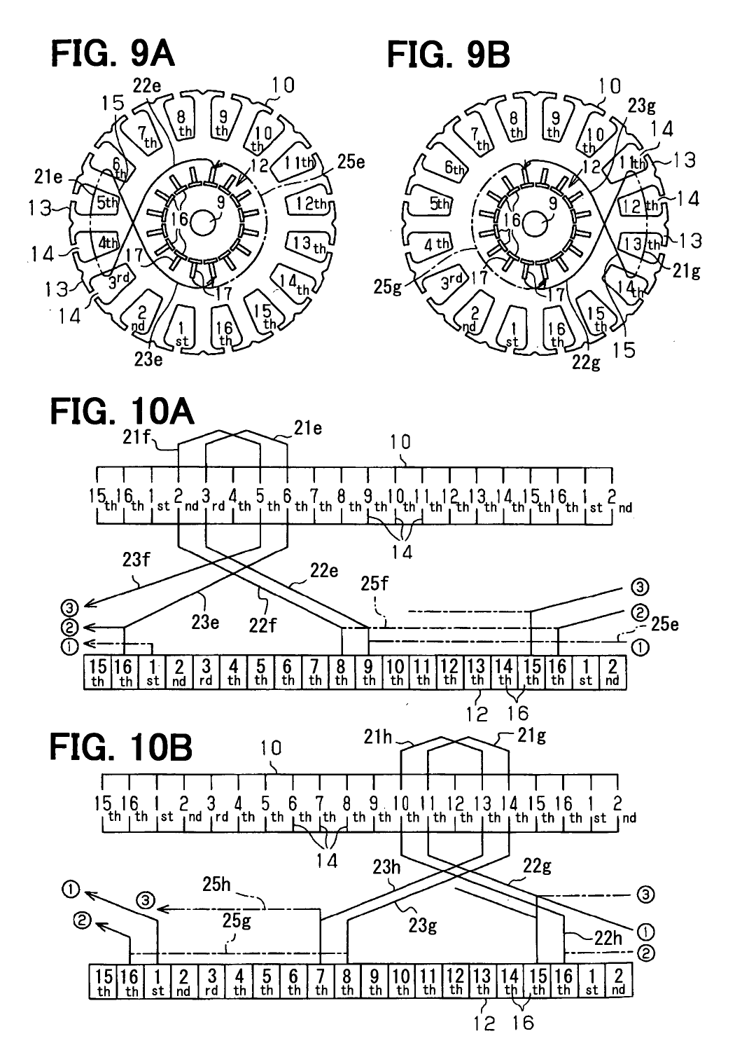

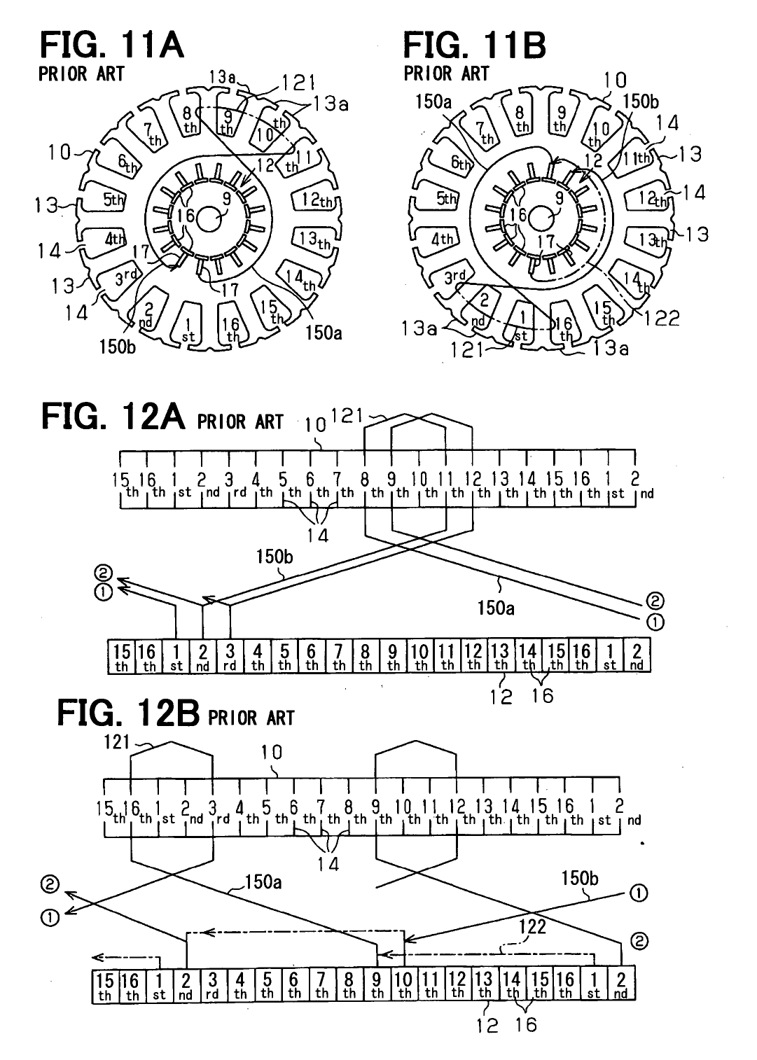

In each of the above embodiments, each winding 15 is wound around the corresponding teeth 13, which make it possible to reduce the angle between the start segment (e.g., the first segment 16) and the finish segment (e.g., the tenth segment 16) about the rotatable shaft 9. Alternatively, the winding 15 may be wound around the corresponding teeth 13, which make it possible to increase the angle between the start segment and the finish segment about the rotatable shaft 9. Specifically, in the case of the first embodiment, the winding 15 may be formed between the first segment 16 and the eight segment 16, which is adjacent to the ninth segment 16 that is diametrically opposed to the first segment 16 in FIG. 3. In the case of the second embodiment, as shown in FIGS. 9A and 10A, a short-circuit line 25e, which connects between the first segment 16 and the ninth segment 16, may be formed first, and then a winding 15 (having a start lead 22e, a coil 21e and a finish lead 23e) is formed such that the finish lead 23e of the winding 15 is connected to the sixteenth segment 16. Furthermore, as shown in FIG. 10A, another short-circuit line 25f may be formed to connect between the sixteenth segment 16 and the eighth segment 16, and then a winding 15 (having a start lead 22f, a coil 21f and a finish lead 23f) may be formed such that the finish lead 23f of the winding 15 is connected to the fifteenth segment 16. Also, as shown in FIGS. 9B and 10B, a winding 15 (having a start lead 22g, a coil 21g and a finish lead 23g) may be formed such that the finish lead 23g is connected to the eighth segment 16, and then a short-circuit line 25g, which connects between the eighth segment 16 and the sixteenth segment 16, may be formed. Similarly, as shown in FIG. 10B, a winding 15 (having a start lead 22h, a coil 21h and a finish lead 23h) may be formed such that the finish lead 23h is connected to the seventh segment 16, and then a short-circuit line 25h, which connects between the seventh segment 16 and the fifteenth segment 16, may be formed. In this way, the windings 15 can effectively hold tightly with each other, so that start leads and finish leads of the windings 15 can be held effectively into a compact size.

In each of the above embodiments, the winding machine, which includes the two flyers, is used to wind the windings. The number of the flyers is not limited to two and may be increased to more than two to improve the productivity or may be reduced to one to form a compact winding machine.

In each of the above embodiments, the start lead and the finish lead, which connect the coil to the corresponding segments, have generally the same length. The location of the center one of the teeth 13, around which the coil is wound, may be changed to any other appropriate location.

Additional advantages and modifications will readily occur to those skilled in the art. The invention in its broader terms is therefore not limited to the specific details, representative apparatus, and illustrative examples shown and described. For example, any one or more of the components of any one of the embodiments and modifications may be combined with any one or more of the components of any other one of the embodiments and modifications.

What is claimed is:

1. An armature for a dynamo-electric machine, comprising:
a rotatable shaft;
an armature core that is installed to the rotatable shaft to rotate therewith and includes a plurality of teeth;
a commutator that is installed to the rotatable shaft to rotate therewith and includes a plurality of segments, which are slidably engageable with a plurality of power supply brushes of the dynamo-electric machine that includes two diametrically opposed power supply brushes, wherein the two diametrically opposed power supply brushes are circumferentially displaced from each other by about 180 degrees about a rotational axis of the rotatable shaft and provide generally the same electric potential to corresponding two, respectively, of the plurality of segments, which are engaged with the two diametrically opposed power supply brushes; and
at least one winding, each of which includes a coil, a start lead and a finish lead, wherein:
the coil is wound around at least one of the plurality of teeth for a predetermined number of times;
the start lead connects between the coil and a corresponding start segment among the plurality of segments;
the finish lead connects between the coil and a corresponding finish segment among the plurality of segments; and
the finish segment is located adjacent to a diametrically opposed one of the plurality of segments, which is circumferentially displaced by about 180 degrees from the start segment and is thereby diametrically opposed to the start segment.

2. The armature according to claim 1, wherein a length of the start lead and a length of the finish lead are generally the same.

3. The armature according to claim 1, further comprising at least one short-circuit line, each of which interconnects between corresponding two of the plurality of segments that are circumferentially displaced from each other by about 180 degrees and are thereby diametrically opposed to each other.

4. The armature according to claim 3, wherein one of the corresponding two of the plurality of segments, which are interconnected by the short-circuit line, includes one of the start segment and the finish segment, which are interconnected by one of the at least one winding.

5. The armature according to claim 1, wherein:
the at least one winding includes first and second windings; and
the start lead of the first winding and the finish lead of the second winding are connected to circumferentially adjacent two, respectively, of the plurality of segments.

6. A dynamo-electric machine comprising:
the armature of claim 1;
a motor housing that receives the armature;
a plurality of magnets that are fixed to an inner peripheral surface of the motor housing and are circumferentially arranged one after another at generally equal angular intervals; and
at least one cathode power supply brush and at least one anode power supply brush that are slidably engageable with the plurality of segments of the commutator.

7. The dynamo-electric machine according to claim 6, wherein:
the at least one cathode power supply brush includes first and second cathode power supply brushes, which are circumferentially displaced from each other by about 180 degrees and are thereby diametrically opposed to each other; and
the at least one anode power supply brush includes first and second anode power supply brushes, each of which is circumferentially displaced from each of the first and second cathode power supply brushes by about 90 degrees.

8. A winding method comprising:
connecting a wire to a corresponding start segment among a plurality of segments of a commutator to form a start lead of a winding;
winding the wire around at least one of a plurality of teeth of an armature core to form a coil of the winding after the start lead; and
connecting the wire to a corresponding finish segment among the plurality of segments to form a finish lead of the winding after the coil, wherein the finish segment is located adjacent to a diametrically opposed one of the plurality of segments, which is circumferentially displaced by about 180 degrees from the start segment and is thereby diametrically opposed to the start segment.

9. The winding method according to claim 8, wherein the connecting of the wire to the corresponding start segment, the winding of the wire around the at least one of the plurality of teeth and the connecting of the wire to the corresponding finish segment are performed such that a length of the start lead and a length of the finish lead become generally the same.

10. The winding method according to claim 8, wherein:
the wire and the winding are a first wire and a first winding, respectively;
the winding method further comprising forming a second winding by using a second wire simultaneously with the first winding;
the forming of the second winding includes:
connecting the second wire to a corresponding start segment among the plurality of segments of the commutator to form a start lead of the second winding;
winding the second wire around at least one of the plurality of teeth of the armature core to form a coil of the second winding after the start lead of the second winding such that the coil of the second winding is circumferentially displaced from the coil of the first winding by about 180 degrees; and
connecting the second wire to a corresponding finish segment among the plurality of segments to form a finish lead of the second winding after the coil of the second winding, wherein the finish segment connected with the finish lead of the second winding is located adjacent to a diametrically opposed one of the plurality of segments, which is circumferentially displaced by about 180 degrees from the start segment connected with the start lead of the second winding and is thereby diametrically opposed to the start segment.

11. The winding method according to claim 8, further comprising connecting a short-circuit line between corresponding two of the plurality of segments, which are circumferentially displaced from each other by about 180 degrees and are thereby diametrically opposed to each other.

12. The winding method according to claim 11, wherein the connecting of the short-circuit line includes connecting the short-circuit line to one of the start segment and the finish segment.
